(19) United States
(12) Patent Application Publication
(10) Pub. No.: US 2006/0070292 A1
(43) Pub. Date: Apr. 6, 2006

(54) Fishing rod and tackle transport and storage container for camping unit

(76) Inventor: Kevin F. Fitzgerald, Draper, UT (US)

Correspondence Address: J. David Nelson;NELSON, SNUFFER, DAHLE & POULSEN, P.C., 19885 South State Street, Sandy, UT, 84070, US

(21) Appl. No.: 10/959,831

(22) Filed: Oct. 5, 2004

(51) Int. Cl. A01K 97/06; A01K 97/08

(52) U.S. Cl. 43/54.1; 43/26

(57) ABSTRACT

A fishing rod and tackle transport and storage container for a camping unit such as a travel trailer or a camper which is attachable to the underside of a travel trailer or camper. The container has a rod segment with rod tubes and a tackle segment with a tackle enclosure. The rod tubes are connected to the rear wall of the tackle enclosure and open into the tackle enclosure. The tackle enclosure has a lockable access cover.

### FIELD OF THE INVENTION

This invention is in the field of containers for fishing rods and tackle and in particular the field of containers attachable to vehicles for the transport and storage of fishing rods and tackle.

### BACKGROUND OF THE INVENTION

Devices for the storage and carrying of fishing rods and other fishing tackle are as old as the sport of fishing itself. These devices can perform functions as simple as protecting a single rod, with or without a reel attached, from damage during periods of transport or non-use. These devices include simple fabric satchels, plastic tubes and racks. Rod holders and carriers that are portable and rod holders and carriers that can be affixed on a boat or to the top of a vehicle are known in the art.

A container is needed for secure attachment to camping units, which shall be defined herein to mean travel trailers, fifth wheel trailers, motor homes and campers, for the stowage and transport of fishing rods and tackle. A travel trailer is a mobile camping unit with one or more axles which is pulled behind a vehicle for transport from one location to another. A fifth wheel trailer is a version of travel trailer typically with only one axle or with one tandem axle. A motor home is essentially a self propelled travel trailer with two or more axles. A camper is a mobile camping unit which is fitted onto a pickup truck bed for transport from one location to another, and which generally remains on the pickup truck bed during a period of use.

It is an objective of the present invention to provide a fishing rod and tackle transport and storage container which can be permanently or removably attached to the underside of a camping unit.

It is an objective of the present invention to provide a fishing rod and tackle transport and storage container which can be permanently or removably attached to the bottom frame of a travel trailer.

It is an objective of the present invention to provide a fishing rod and tackle transport and storage container which can be permanently or removably attached to the bottom of the lateral overhang of a camper.

It is a further objective of the present invention to provide a fishing rod and tackle transport and storage container for a camping unit which is readily accessible from the exterior of the camping unit.

It is a still further objective of the present invention to provide a fishing rod and tackle transport and storage container for a camping unit which is lockable and securable.

It is a still further objective of the present invention to provide a fishing rod and tackle transport and storage container for a camping unit which is weather protected.

### SUMMARY OF THE INVENTION

The rod and tackle container of the present invention is preferably installed, for a typical travel trailer, with the access cover located between the entry door and the rear wheel well. This installation position is compatible with most travel trailers and is preferred because of the utility and convenience of this position and because it is relatively protected, minimizing the probability of damage to the rod and tackle container. However, for travel trailers which have the entry door too close to the rear wheel well, the rod and tackle container can be installed on the side of the travel trailer opposite the entry door or forward of the entry door. Some travel trailers come equipped with a lower skirt and have a built in storage area. For those travel trailers, the storage door can be used for the access cover.

The rod and tackle container has a rod segment and a tackle segment. The rod segment consists of one or more rod tubes affixed to the rear wall of the tackle enclosure of the tackle segment. The tackle enclosure has a generally horizontal top wall with a generally horizontal upper top wall section and a generally horizontal lower top wall section. The tackle enclosure is attached to the underside of the travel trailer with the rod tubes extending from the tackle enclosure beneath the floor of the travel trailer and beneath any floor frame members. The rod tubes are also attached to the underside of the travel trailer or floor frame members.

While aluminum is preferred because of its light weight, strength and resistence to corrosion, other materials such as fiberglass, plastic or steel can be used for the tackle enclosure. The tackle enclosure preferably has a hinged and lockable access cover. A seal gasket can be mounted to the access cover inside perimeter or to the tackle enclosure front edge to enhance the weather resistence of the tackle enclosure.

The rod tubes can be constructed of any common material such as aluminum, fiberglass, PVC or other types of plastic, or steel. Each of the rod tubes can be threaded, welded, gasketed or otherwise sealed to the tackle enclosure. Bells, couplings, bushings or other fittings on the inside end of the rod tubes can be used prevent the separation of the rod tubes from the rear wall of the tackle enclosure. The rod tube outside end for each rod tube will preferably be covered with a non-removable end cap or otherwise sealed for security and weather resistence. While rod tubes with a circular cross section are preferred, other types of piping, tubing or conduit with other cross sections could be used so long as they do not restrict the insertion and removal of the rods. Likewise, the internal dimensions of the rod tubes can be varied to accommodate differing sizes of rods. Unistruts are preferred for attaching the rod and tackle container to the underside of a travel trailer. Besides providing for the rod and tackle container to be securely affixed to the frame of the travel trailer so that it does not become unattached or loose during transport, the anchor means needs to provide for vandalism and theft resistance.

The embodiments of the rod and tackle transport and storage container used for travel trailers can also be used for fifth wheel trailers and motor homes. However, generally fifth wheel trailers and motor homes will have a lower skirt shown configuration and, in the case of a motor home, the rod tubes pass beneath the drive shaft, thereby reducing the ground clearance.

A preferred embodiment of the rod and tackle container for use with a camper type of camping unit can be affixed beneath the lateral overhang on either side of a typical camper. This lateral overhang is created by the addition of width to the camper to accommodate an adequate lateral sleeping dimension. For this embodiment the access cover is preferably positioned flush with the rear wall of the camper. As with the travel trailer embodiment, each rod tube is affixed to the tackle enclosure in a tube collar in the rear wall. The upper portion of the tackle enclosure may extend over the wheel well of the truck used to transport the camper. Because of the limited lateral space, the rod tubes may be vertically stacked. Again, a preferred anchor means for affixing and securing the rod tubes to the camper lateral overhang underside is a unistrut arrangement, with the rod tubes being affixed to the unistrut arrangement with tube clamps. A camper may be manufactured with a storage compartment under the lateral overhang on one or both sides of the camper with a storage door for access and the storage door may be used as the access cover for the present invention.

### BRIEF DESCRIPTION OF THE DRAWINGS

FIG. 1 is a perspective side view of a travel trailer illustrating the installation of a preferred embodiment of the rod and tackle storage container of the present invention in a preferred position on the travel trailer.

FIG. 2 is a perspective side view of a travel trailer with an extended skirt and a built in storage box, illustrating the installation of a preferred embodiment of the rod and tackle storage container of the present invention in a preferred position on the travel trailer.

FIG. 3 is a front perspective detail of a preferred embodiment of the rod and tackle storage container of the present invention.

FIG. 4 is a side perspective detail of a preferred embodiment of the rod and tackle storage container of the present invention.

FIG. 5 is a front view perspective detail of a preferred embodiment of the rod and tackle storage container of the present invention for installation on a camper.

FIG. 6 is a front view perspective detail of a preferred embodiment of a rod tube anchor means for a camper embodiment of the present invention utilizing a unistrut arrangement.

FIG. 7 is a side view cross-section detail of a preferred embodiment of the tube collar and the connection of the rod tubes to the tackle enclosure.

### DETAILED DESCRIPTION

As stated above, the term “camping unit” as used in this detailed description, the claims, and elsewhere in this application, shall be defined to mean a travel trailer, a fifth wheel trailer, a motor home or a camper.

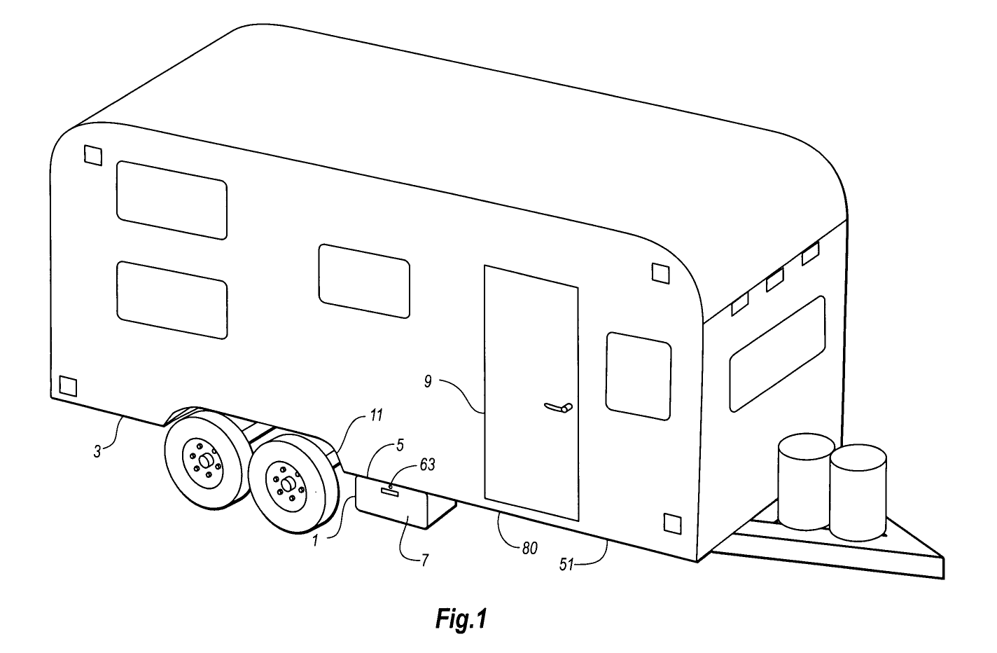

Referring first to FIG. 1 a preferred embodiment of the rod and tackle container 1 of the present invention installed on a typical travel trailer 3 type of camping unit is shown. The installation position 5 shown, with the access cover 7 located between the entry door 9 and the rear wheel well 11. This installation position is preferred because of the utility and convenience of this position and because it is relatively protected, minimizing the probability of damage to the rod and tackle container. This installation position is compatible with most brands and models of travel trailers. However, for travel trailers which have the entry door too close to the rear wheel well, the rod and tackle container can be installed on the side of the travel trailer opposite the entry door. The embodiments of the rod and tackle container shown in FIGS. 1-4 can readily be installed on the side opposite the entry door. Further, the embodiments shown in FIGS. 1-4 can also be installed forward of the entry door.

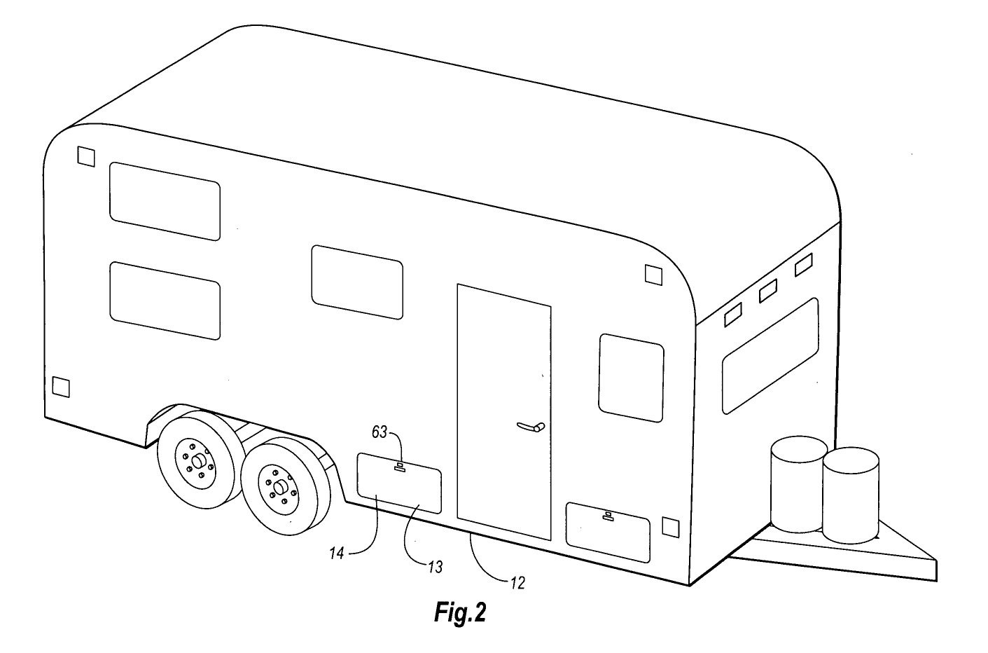

Referring now to FIG. 2, some travel trailers come equipped with a lower skirt 12 and have a built in storage area 13 with a storage door 14 in approximately the position shown for the access cover. For those travel trailers, the storage door can be used for the access cover thereby preserving the appearance of the travel trailer.

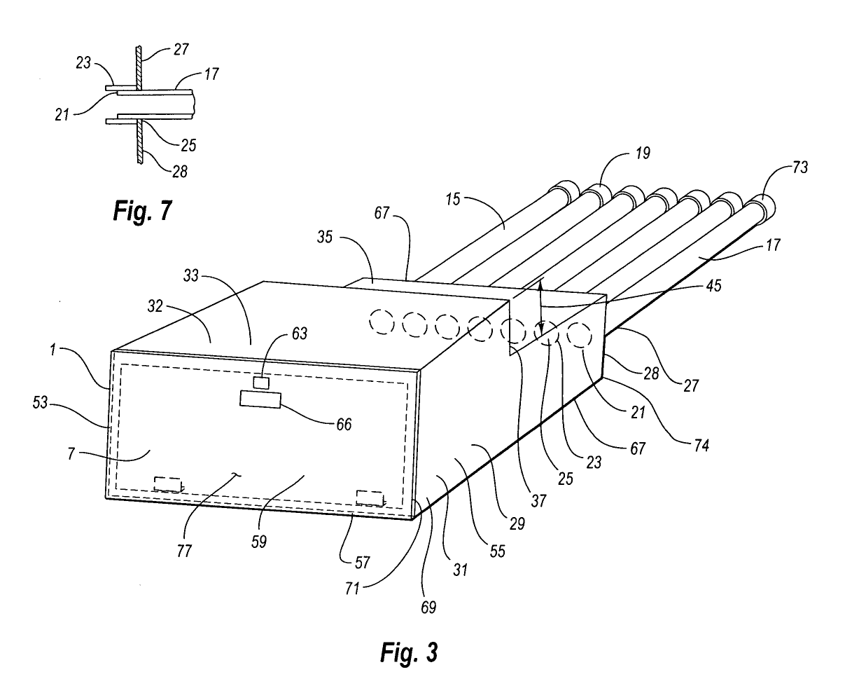

Referring now to FIG. 3 the rod segment 15 of the preferred embodiment shown consists of one or more rod tubes 17 having a tube outside end 19 and tube inside end 21. The tube inside end is affixed to a tube collar 23 which circumscribes a tube opening 25 in a generally vertical lower rear wall section 28 of the generally vertical rear wall 27 of the tackle enclosure 29 of the tackle segment 31.

For the embodiment shown in FIG. 3, the tackle enclosure has a generally horizontal top wall 32 with a generally horizontal upper top wall section 33 and a generally horizontal lower top wall section 35. The upper top wall section is connected to the lower top wall section by a generally vertical upper rear wall section 37.

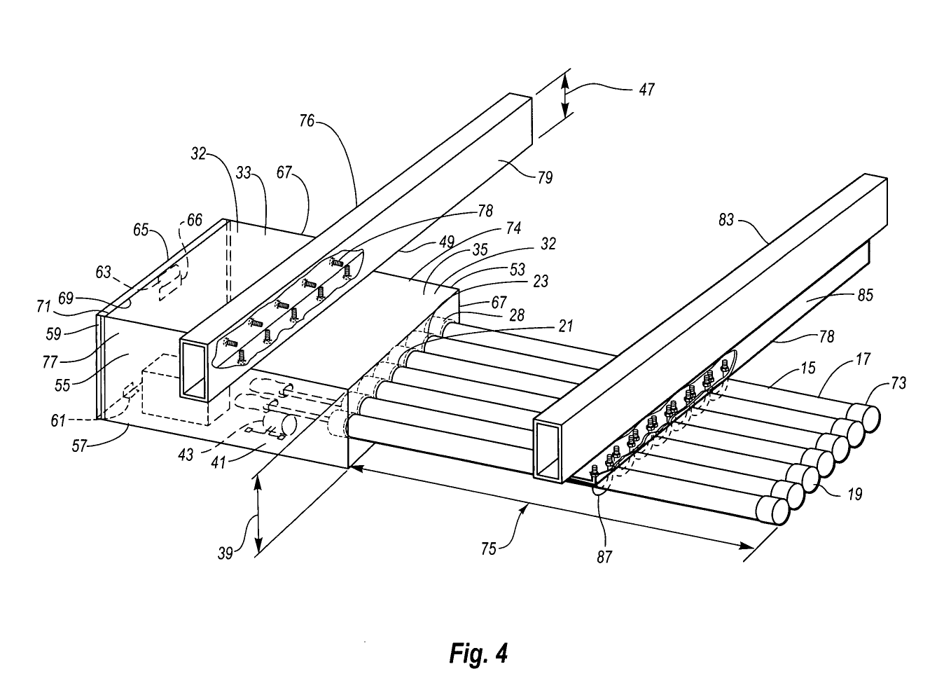

Referring also to FIG. 4, the lower rear wall section height 39 is selected to allow for the insertion of a rod 41 in a rod tube without removing the reel 43. The upper rear wall section height 45 will be approximately equal to the trailer outside frame member height 47 thereby providing for the lower top wall to fit generally flush with the trailer outside frame member bottom 49 when the upper top wall is placed flush against the bottom of the trailer floor 51 as shown in FIG. 1. The tackle enclosure also has a left side wall 53, a right side wall 55, a bottom wall 57, and a front wall 59. For the embodiment shown in FIGS. 1-4 the front wall is an access cover 7 which will preferably be connected to the bottom wall by one or more access hinges 61. The access cover also preferably equipped with a lockable latch 63 which mates with a latch receptacle 65 affixed to the upper top wall. Other hinge means, latch means, and lock means for the access cover will be known to persons skilled in the art. An access handle 66 of any of a variety of types known to persons skilled in the art can also assist with the operation of the access cover.

For preferred embodiments the corner joints 67 between adjacent walls, excepting only the joints between the front wall and adjacent walls if the front wall is comprised entirely of an access cover as shown in FIGS. 1-4, are continuous and sealed. The inventor has found that aluminum sheeting is a preferred material for the construction of the tackle enclosure with the corner joints consisting of bends or welds. While aluminum is preferred because of its light weight, strength and resistance to corrosion, other materials such as fiberglass, plastic or steel can be used. A seal gasket can be mounted to the access cover inside perimeter 69 or to the tackle enclosure front edge 71 to enhance the weather resistence of the tackle enclosure. Other embodiments may provide for the front wall to be affixed to the top wall, left side wall, right side wall, and bottom wall, with an access cover mounted in or to the front wall. Also multiple access covers can be provided. Again hinging, latching and locking means for various access cover variations will be known to persons skilled in the art.

The rod tubes can be constructed of any common material such as aluminum, fiberglass, PVC or other types of plastic, or steel. Each of the rod tubes can be threaded, welded, gasketed or otherwise sealed to a respective tube collar 23 by means known to persons skilled in the art. Referring to FIG. 7, a detail of a preferred embodiment of the tube collar 23 is shown. If PVC pipe is used for the rod tubes, the tube collar can be a simple solvent weld or threaded coupling. For other common types of pipe or conduit used for the rod tubes, a threaded coupling or other types of bushings or couplings which will be known to persons skilled in the art, can be used to prevent the separation of the rod tubes from the rear wall of the tackle enclosure. Other embodiments may provide for the rod tubes to be threaded or welded directly to a tube collar which is integral with the rear wall of the tackle enclosure. Other means for securing the rod tubes to the rear wall of the tackle enclosure will be known to persons skilled in the art.

The rod tube outside end 19 for each rod tube will preferably be covered with a non-removable end cap 73 or otherwise sealed for security and weather resistence.

Also, other preferred embodiments of the tackle segment may eliminate the tackle enclosure extended segment 74, incorporating a continuous top wall and a continuous rear wall, with the top wall and the bottom wall extending only as far as the outside edge 76 of the outside frame member 79. While this reduces the storage capacity of the tackle enclosure, it increases the rod tube length 75 thereby increasing the length of the rod that can be stored in the rod tubes and improving access to the rod tubes from the access opening 77.

While the rod tubes shown in FIGS. 3-4 have a circular cross section, other types of piping, tubing or conduit with circular or other cross sections could be used so long as they do not restrict the insertion and removal of the rods. Likewise, the internal dimensions of the rod tubes can be varied to accommodate differing sizes of rods. Some preferred embodiments incorporate two or more different sizes of rod tubes, thereby accommodating a variety of rod sizes. Heavy duty rods, which have a larger rod shaft and larger eyes will require a rod tube with larger inside dimensions.

Referring to FIGS. 3-4, a preferred attachment means 78 is shown for attaching the rod and tackle transport and storage container of the present invention to the underside 80 of a travel trailer as shown in FIG. 1. The upper rear wall section 37 and lower top wall section 35 can be affixed to the outside frame member 79. For the embodiment shown the rod segment 15 is affixed to the opposing frame member 83 by a rod segment unistrut 85 which is attached to the frame member and a tube clamp 87 is used to affix each rod tube to the unistrut. For the preferred embodiment shown the tackle enclosure can be affixed directly to the outside frame member with fasteners as shown or the tackle enclosure can be attached to a enclosure unistrut which can then be affixed to the outside frame member. Other anchor means for affixing and securing the rod and tackle transport and storage container to a travel trailer will be known to persons skilled in the art. Besides providing for the rod and tackle container to be securely affixed to the frame of the travel trailer so that it does not become unattached or loose during transport, the anchor means needs to provide for vandalism and theft resistance.

The embodiments of the rod and tackle transport and storage container shown in FIGS. 1-4 can also be used for fifth wheel trailers and motor homes. However, generally fifth wheel trailers and motor homes will have a lower skirt shown configuration similar to that shown in FIG. 2. An additional concern in the case of a motor home is that motor homes generally have a rear axle drive. This requires that the rod tubes pass beneath the drive shaft, thereby reducing the ground clearance. However, the embodiments shown in FIGS. 1-4 are readily adaptable to fifth wheel trailers and motor homes.

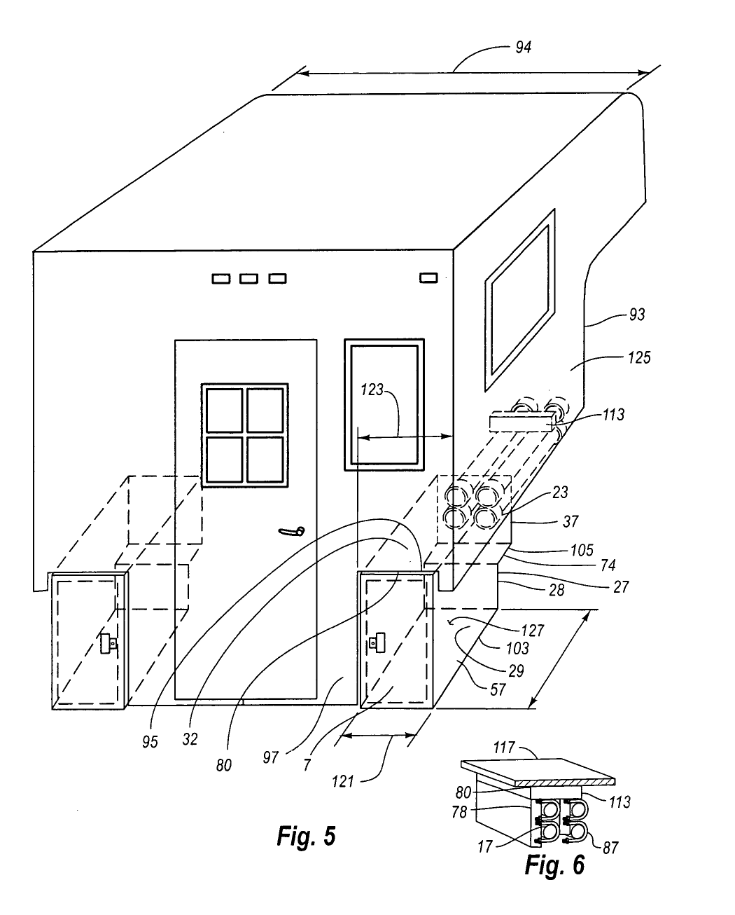

Referring now to FIG. 5 a preferred embodiment of the rod and tackle container 1 for use with a camper 93 type of camping unit is shown. This embodiment can be affixed beneath the lateral overhang 95 on either side of a typical camper. This lateral overhang is created by the addition of width to the camper to accommodate an adequate lateral sleeping dimension 94. For this embodiment the access cover 7 is preferably positioned flush with the rear wall 97 of the camper. This embodiment has a uniform top wall 32 and the bottom wall 57 is divided into a lower bottom wall section 103 and an upper bottom wall section 105 connected by the generally vertical lower rear wall section 28. As with the embodiment shown in FIGS. 3-4, each rod tube 17 is affixed to the tackle enclosure 29 in a tube collar 23 in the rear wall 27, but for this embodiment the rod tubes are affixed to the upper rear wall section 37. The enclosure extended segment 74 provides for extending the tackle enclosure over the wheel well of the truck used to transport the camper. Because of the limited lateral space, the rod tubes may be vertically stacked as shown in FIG. 5 and in the detail shown in FIG. 6.

A preferred anchor means 78 for affixing and securing the rod tubes to the camper lateral overhang underside 80 is the unistrut arrangement 113 shown in FIG. 6 with the rod tubes 17 being affixed to the unistrut arrangement with tube clamps 87. The tackle enclosure can be affixed and secured to the underside 80 of the camper overhang by using fasteners to affix the top wall of the tackle enclosure directly to the frame or sheeting of the underside of the overhang. Other anchor means for the tackle segment and the rod segment for this embodiment will be known to those skilled in the art. The camper may have been manufactured with a storage compartment under the lateral overhang on one or both sides of the camper with a storage door for access. For those models of campers, the storage door may be used as the access cover for the present invention, thereby preserving the appearance of the camper.

The lower bottom wall section length 117 will generally be determined by the distance from the camper rear wall 97 to the tire well. The top wall width and the bottom wall width 121 will generally be determined by the overhang width 123 of the camper sidewall 125. Also, although the embodiment shown in FIG. 5 provides for the rod handles and reels which may be attached to the rods to be out of the main storage cavity 127, other preferred embodiments may have a uniform rear wall and uniform bottom wall thereby providing for the rear wall to be positioned so that it will be rearward of the tire well. While this embodiment reduces the effective storage capacity of the tackle segment it does improve the accessibility to the rod tubes and the rods positioned in the rod tubes.

Other embodiments of the invention and other variations and modifications of the embodiments described above will be obvious to a person skilled in the art. Therefore, the foregoing is intended to be merely illustrative of the invention and the invention is limited only by the following claims and the doctrine of equivalents.

What is claimed is:

1. Fishing rod and tackle transport and storage container for a camping unit, the camping unit having an underside, the camping unit having an outside wall, the container comprising a rod segment and a tackle segment, the rod segment comprising one or more rod tubes, the tackle segment comprising a tackle enclosure, the tackle enclosure having a top wall and a rear wall, the top wall being dimensioned to provide for the tackle enclosure to be positioned beneath the underside with the top wall generally conforming to the underside and the rear wall being dimensioned to provide for each rod tube to be connected to the rear wall in a rod insertion opening in the rear wall, each rod tube extending generally horizontally from the rear wall beneath the underside and being attachable to the underside, the tackle enclosure having a front wall with an access cover, and the access cover being positionable to allow the insertion and removal through the tackle enclosure of a respective fishing rod to and from each rod tube.

2. The fishing rod and tackle transport and storage container recited in claim 1 wherein the access cover is hinged.

3. The fishing rod and tackle transport and storage container recited in claim 1 wherein the access cover is lockable.

4. The fishing rod and tackle transport and storage container recited in claim 1 wherein the camping unit has an exterior frame member supporting the underside of the camping unit, wherein the rear wall has an upper rear wall section and a lower rear wall section and the top wall has front top wall section and a rear top wall section, the upper rear wall section and the lower rear wall section being connected by the rear top wall section, the upper rear wall section being dimensioned to provide for the rear top wall section to extend beneath the exterior frame member, the rod insertion openings being in the lower rear wall section.

5. The fishing rod and tackle transport and storage container recited in claim 1 wherein the camping unit has a lateral overhang, wherein the tackle enclosure has a bottom wall, the rear wall has an upper rear wall section and a lower rear wall section and the bottom wall has a front bottom wall section and a rear bottom wall section, the upper rear wall section and the lower rear wall section being connected by the rear bottom wall section, the upper rear wall section and the rear bottom wall section being dimensioned to provide for the rear bottom wall section to extend beneath the lateral overhang while providing tire well clearance, the rod insertion openings being in the upper rear wall section.

6. Fishing rod and tackle transport and storage container for a travel trailer, the travel trailer having a floor and one or more frame members beneath the floor and supporting the floor, the travel trailer having an outside wall and having an exterior frame member with an exterior surface, the floor having an exterior portion between the exterior frame member and the outside wall, the container comprising a rod segment and a tackle segment, the rod segment comprising one or more rod tubes, the tackle segment comprising a tackle enclosure, the tackle enclosure having a top wall and a rear wall, the top wall and the rear wall respectively being dimensioned to provide for the tackle enclosure to be positioned beneath the exterior portion of the travel trailer floor with the top wall generally conforming to the exterior portion of the travel trailer floor and the rear wall generally conforming to the exterior surface of the exterior frame member and extending below the exterior frame member, each rod tube being connected to the rear wall in a rod insertion opening in the rear wall, each rod tube extending generally horizontally from the rear wall of the tackle enclosure beneath the trailer frame and being attachable to the trailer frame, the tackle enclosure having a front wall with an access cover, the access cover being positionable to allow the insertion and removal through the tackle enclosure of a respective fishing rod to and from each rod tube.

7. The fishing rod and tackle transport and storage container recited in claim 6 wherein the access cover is hinged.

8. The fishing rod and tackle transport and storage container recited in claim 6 wherein the access cover is lockable.

9. The fishing rod and tackle transport and storage container recited in claim 6 wherein the rear wall has an upper rear wall section and a lower rear wall section and the top wall has front top wall section and a rear top wall section, the upper rear wall section and the lower rear wall section being connected by the rear top wall section, the upper rear wall section being dimensioned to provide for the rear top wall section to extend beneath the exterior frame member, the rod insertion openings being in the lower rear wall section.

10. Fishing rod and tackle transport and storage container for a camper, the camper having a lateral overhang and an underside beneath the lateral overhang, the camper having an outside wall and a back wall, the container comprising a rod segment and a tackle segment, the rod segment comprising one or more rod tubes, the tackle segment comprising a tackle enclosure, the tackle enclosure having a top wall and a rear wall, the top wall and the rear wall respectively being dimensioned to provide for the tackle enclosure to be positioned beneath the camper lateral overhang with the top wall generally conforming to the lateral overhang, each rod tube being connected to the rear wall of the tackle enclosure in a rod insertion opening in the rear wall, each rod tube extending generally horizontally from the rear wall of the tackle enclosure beneath the lateral overhang and being attachable to the lateral overhang, the tackle enclosure having a front wall with an access cover, the access cover being positionable to allow the insertion and removal through the tackle enclosure of a respective fishing rod to and from each rod tube.

11. The fishing rod and tackle transport and storage container recited in claim 10 wherein the access cover is hinged.

12. The fishing rod and tackle transport and storage container recited in claim 10 wherein the access cover is lockable.

13. The fishing rod and tackle transport and storage container recited in claim 10 wherein the tackle enclosure has a bottom wall, the rear wall has an upper rear wall section and a lower rear wall section and the bottom wall has a front bottom wall section and a rear bottom wall section, the upper rear wall section and the lower rear wall section being connected by the rear bottom wall section, the upper rear wall section and the rear bottom wall section being dimensioned to provide for the rear bottom wall section to extend beneath the lateral overhang while providing tire well clearance, the rod insertion openings being in the upper rear wall section.
